(19) United States
(12) Patent Application Publication
(10) Pub. No.: US 2005/0221050 A1
(43) Pub. Date: Oct. 6, 2005

(54) Two-layered optical recording medium, method for manufacturing the same, and, method and apparatus for optical recording and reproducing using the same

(76) Inventors: Michiaki Shinotsuka, Hiratsuka-shi (JP); Hiroyuki Iwasa, Yokohama-shi (JP); Masaru Shinkai, Yokohama-shi (JP); Tatsuo Mikami, Ashigarakami-gun (JP); Yuki Nakamura, Tokyo (JP); Tohru Yashiro, Ebina-shi (JP)

Correspondence Address: DICKSTEIN SHAPIRO MORIN & OSHINSKY LLP, 2101 L Street, NW, Washington, DC, 20037, US

(21) Appl. No.: 11/082,834

(22) Filed: Mar. 18, 2005

(30) Foreign Application Priority Data
Mar. 19, 2004 (JP) 2004-080007

(51) Int. Cl. B32B 3/02

(52) U.S. Cl. 428/64.4

(57) ABSTRACT

The object of the present invention is to provide a two-layered optical recording medium using dye layers for a recording layer which triggers no jitter noise and the like against not only a red laser beam but also against low-power output laser beam such as a blue laser beam, has high archival properties, and is capable of high-density recording, and a method and an apparatus for the optical recording and reproducing. Thus, the optical recording medium comprises a substrate, and a first information layer, and a second information layer disposed on the substrate through an intermediate layer to perform recording and reproducing on the first information layer and the second information layer respectively by irradiating laser beam from the first information layer side. The first information layer comprises at least a first dye layer and a first reflective layer adjacent to the first dye layer; the second information layer comprises at least a second dye layer, a second reflective layer adjacent to the second dye layer; the first reflective layer is semi-translucent; and a first protective layer and a second protective layer are disposed between the second dye layer and the intermediate layer.

### BACKGROUND OF THE INVENTION

1. Field of the Invention

The present invention relates to a two-layered optical recording medium in which recording and reproducing of information are performed by irradiating laser beam to induce optical changes to transmittance, reflectance or the like of a recording material and write once read many are enabled. The present invention also relates to a method for recording and reproducing using the single-sided optical recording medium, and an apparatus for the optical recording and reproducing.

2. Description of the Related Art

With respect to an optical recording medium which has a recording layer made from an organic dye, as the organic dye, an optical recording medium using a phthalocyanine dye (Japanese Patent Application Laid-Open (JP-A) No. 58-183296), a cyanine dye (JP-A No. 57-82093), a phenanthrene dye, a naphthoquinone dye, or the like have been known in the art.

A recordable optical recording medium (CD-R) in which a recording layer comprising an organic dye, a reflective layer, and an UV resin protective layer are disposed on a substrate requires high reflectance to satisfy the CD standard. Therefore, there is a need to develop an organic dye which has a high refractive index in the reproduction wavelength (770 nm to 830 nm) and ensures remarkable stability (For instance, DVD±R, which is a DVD recordable disk and has a reproduction wavelength of 630 nm to 680 nm).

As for the conventional CD-R and DVD±R, a number of applications have been proposed, which employs the structure of layers such as a cyanine dye layer/a metal reflective layer, a phthalocyanine dye layer/a metal reflective layer, an azo metal chelate dye layer/a metal reflective layer. For example, there are the one that uses a phthalocyanine dye (Japanese Patent Application Laid-Open (JP-A) No. 04-226390), the one that uses an azo metal chelate dye (JP-A No. 04-46186).

However, these optical recording media described above respectively have only one dye layer (recording layer) and allows only storage capacity for the portion of one dye layer, and further increases in storage capacity of CD-R and DVD±R are desired.

Correspondingly, to increase the storage capacity of an optical disk, an optical recording medium having multiple recording layers has been proposed. With an optical recording medium having two or more recording layers, it is possible to access various layers by changing the lens focal point. For instance, the specification of U.S. Pat. No. 5,202,875 describes an optical disc drive system having a plurality of data layers. The optical disk, however, comprises either a plurality of substrates in which data layers are individually arranged at intervals with air gap, or a plurality of data layers of a solid-structure.

Also, U.S. Pat. No. 4,450,553 employs a solid-structure in which a plurality of data layers is disposed, and the individual data layers are CD type data layers.

International Publication Nos. WO2000/016320 and WO2000/023990 specifications describe that it is preferable that an information layer comprises at least two or more layers. Namely, in the case of a two-layered structure, for example, there are structures such as the one with a dielectric layer/a recording layer disposed from laser beam irradiation side, the one with a recording layer/a reflective layer disposed from laser beam irradiation side, and the one with a reflective layer/a recording layer disposed from laser beam irradiation side. The specifications also describe that in the case of a three-layered structure, for example, there are structures such as the one with a dielectric layer/a recording layer/a dielectric layer disposed from the substrate side, the one with a dielectric layer/a recoding layer/a reflective layer disposed from the substrate side, and in the case of a four-layered structure, for example, there are structures such as the one with a dielectric layer/a recording layer/a dielectric layer/a reflective layer. Further, a five-layered structure is disclosed in the specifications, in which a first reflective layer/a dielectric layer/a recording layer/a dielectric layer/a second reflective layer are disposed. It is described that by arranging a thin recording layer adjacent to a dielectric layer, as above, it becomes possible to prevent degradation of a thin layer when repeatedly recorded and to set an optical change of recorded information greater. However, the above optical recording media do not really allow for the case of a two-layered using two dye layers, and utilize a recording layer consisted of only a dye layer or a phase-change layer, and the above optical media are not taking a structure allowing for compatibility with reflectance, DVD, and the like.

Besides, Japanese Patent Application Laid-Open (JP-A) Nos. 2001-084643 and 2001-10709 respectively disclose an optical recording medium having two recording layers. However, both of the proposed optical recording media comprise recording layers made from inorganic materials.

In addition, as for a recordable optical recording medium using conventional dyes as a recording material requires taking a structure where a metal layer is arranged adjacent to a dye layer to increase the reflectance and to record a small recording mark, therefore, an optical recording medium having tow or more recording layers has not yet been realized.

Dye materials have been utilized since CD generation, but developments of the technique for making a recording layer made from dye materials multilayered have not been completed yet, because a two-layer structured optical recording medium needs achieving a balance between transmittance relative to recording and reproducing laser beam and absorbency, and it is technically difficult. For instance, in the case of a two-layer structured optical recording medium using dyes as a recording material, the information layers disposed at the innermost side far from the incident laser beam is liable to accumulate heat, and it is required to improve heat dissipatability of the information layers. However, if the thickness of a reflective layer having high thermal conductivity is overly thickened, it develops a problem that recording sensitivity becomes worse and jitters of recording and reproducing properties have become degraded. Besides, if a recording layer is formed to be sandwiched between two protective layers for serving to control a reflectance, it develops the problems that the thickness of the layer becomes increased and uneven, and the jitter of recording and reproducing properties becomes degraded.

### SUMMARY OF THE INVENTION

The object of the present invention is to provide a single-sided two-layered optical recording medium using dye layers for a recording layer which triggers no jitter noise and the like against not only a red laser beam but also against low-power output laser beam such as a blue laser beam, has high archival properties, and is capable of high-density recording, and the method for manufacturing the two-layered optical recording medium, and, a method and an apparatus for the optical recording and reproducing.

The two-layered optical recording medium according to the present invention comprises a substrate, a second information layer, an intermediate layer, and a first information layer disposed on the substrate in this sequence and is characterized in that recording and reproducing are performed respectively on the first information layer and the second information layer by irradiating laser beam from the first information layer side; the first information layer comprises at least a first dye layer which comprises an organic dye, and a first reflective layer disposed on the first dye layer; the second information layer comprises at least a second dye layer which comprises an organic dye, and a second reflective layer disposed on the second dye layer; the first reflective layer is semi-translucent; and the two-layered optical recording comprises a first protective layer, and a second protective layer disposed between the second dye layer and the intermediate layer.

The two-layered optical recording medium of the present invention triggers no jitter noise and the like against not only a red laser beam but also against low-power output laser beam such as a blue laser beam, has high archival properties, and allows high-density recording.

According to the method for manufacturing the two layered optical recording medium of the present invention, a plurality of layers are formed and disposed by using same materials to form any one of a first protective layer and a second protective layer, wherein the two layered optical recording medium comprises a substrate, a second information layer, an intermediate layer, and a first information layer disposed on the substrate in this sequence and is characterized in that recording and reproducing are performed respectively on the first information layer and the second information layer by irradiating laser beam from the first information layer side; the first information layer comprises at least a first dye layer which comprises an organic dye, and a first reflective layer disposed on the first dye layer; the second information layer comprises at least a second dye layer which comprises an organic dye, and a second reflective layer disposed on the second dye layer; the first reflective layer is semi-translucent; and the two-layered optical recording comprises a first protective layer, and a second protective layer disposed between the second dye layer and the intermediate layer. As a result, it makes possible to obtain a uniformly formed thickness for the first protective layer and the second protective layer, a similar degree of reflectance, and favorable jitter results.

According to the optical recording and reproducing method of the present invention, at least any one of recording and reproducing of signal information in the first dye layer and the second dye layer is performed by irradiating laser beam the two-layered optical recording medium of the present invention from the first information layer side. The optical recording and reproducing method using the two-layered optical recording and reproducing medium of the present invention effectively enables any one of recording and reproducing of information in a stable and assured manner.

According to the optical recording and reproducing apparatus of the present invention, information is recorded on an optical recording medium by irradiating laser beam to the recording medium from light source, and the optical recording medium is the two-layered optical recording medium of the present invention. The optical recording and reproducing apparatus of the present invention effectively enables at least any one of recording and reproducing of information in a stable and assured manner.

### BREIF DESCRIPTION OF THE DRAWING

FIG. 1 is a cross-sectional view showing an exemplary layer structure of a two-layered optical recording medium according to the present invention.

FIG. 2 shows a push-pull of the second information layer when the thickness of the second reflective layer of the two-layered optical recording medium of Example 1 is changed.

### DESCRIPTION OF THE PREFERRED EMBODIMENTS

(Two-Layered Optical Recording Medium)

The two-layered optical recording medium of the present invention comprises a substrate, and a first information layer and a second information layer disposed through an intermediate layer on the substrate, a first protective layer, a second protective layer, and further comprises other layers as required.

The first information layer comprises at least a first dye layer and a first reflective layer adjacent to the first dye layer and further comprises other layers as required.

The second information layer comprises at least a second dye layer and a second reflective layer adjacent to the second dye layer and further comprises other layers as required.

Here, with the conventional layer structure where an organic dye layer, a metal reflective layer, and an UV resin protective layer are disposed on the substrate in this sequence, and when Ag is used for a reflective layer and the thickness of the reflective layer is set to approx. 100 nm, it was impossible to make a recording layer two-layer structured, because laser beam hardly transmits to the ranges of red LD wavelength (630 nm to 800 nm) or blue LD wavelength (360 nm to 430 nm).

Correspondingly, the two-layered optical recording medium according to the present invention is a dye-type optical recording medium utilizing reflectance changing phenomena through optical hole burning, deformation, or reflective index changes associated with light absorbing functions of dye layers. The reflective layer of the present invention is disposed adjacent to the dye layer as in conventional optical recording media but is characterized in that the second information layer has two protective layers (a first and a second protective layers), and the two protective layers individually have a different function. It is noted that the first information layer has the same structure as in conventional optical recording media.

The use of dyes as a recording material makes it possible to realize a low jitter in high-density recording with the shortest mark length of 0.3 μm or less, but when a short-wavelength laser diode (for example, a wavelength of 410 nm or less) is used in order to realize high-density recording, it is required to give further consideration to the quenching structure. Particularly it is important to consider one beam overwrite properties in the case where a small converging laser beam having a wavelength of 500 nm or less, a numerical aperture of lens (NA) of 0.55 or more are used, because planarizing temperature distribution in the direction of the mark width have an influence upon adjacent tracks. Consequently, it is found that a layer structure stated below is necessary. The tendency of the layer structure applies to an optical recording medium responding to DVR in which an optical apparatus having a wavelength of 350 nm to 420 nm, a numerical aperture of lens (NA) of approx. 0.85.

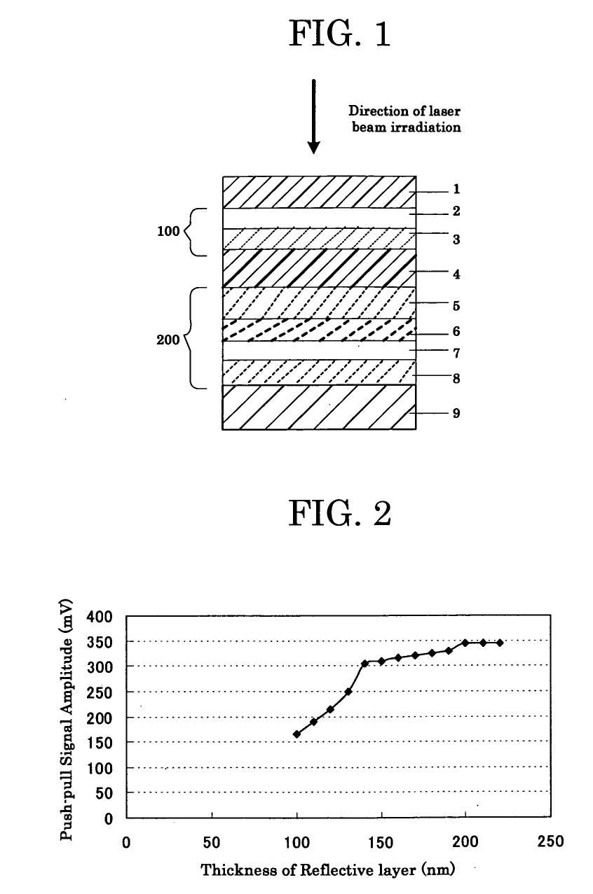

FIG. 1 is schematically showing a cross-sectional view of an exemplary layer structure of a single-sided two-layered optical recording medium according to the present invention.

The two-layered optical recording medium shown in FIG. 1 comprises a cover substrate 1, a first dye layer 2, a first reflective layer (semi-translucent layer) 3, an intermediate layer 4, a first protective layer 5, a second protective layer 6, a second dye layer 7, a second reflective layer 8, and a substrate 9. In this case, the first dye layer 2 and the first reflective layer (semi-translucent layer) 3 constitute a first information layer, and the first protective layer 5, the second protective layer 6, the second dye layer 7, and the second reflective layer 8 constitute a second information layer.

The second protective layer adjacent to the second dye layer is configured to have a function for controlling recording sensitivity besides a function for protecting dyes. The first protective layer is configured to have a function for letting heat slip away to reduce thermal deformation of the reflective layer accompanied by heat generation of the second dye layer when recorded. The structure stated above allows improving cooling power of an optical recording medium and increasing the recording capacity in the direction of irradiation of laser beam. The structure makes tracking stabilized, because the push-pull of groove signal properties will not become reduced in size. Moreover, tracking will be further stabilized, and recording and reproducing properties will become favorable, since wobble signal (address signal) is also one of groove signal properties and has very little deformation caused by heat, as in the push-pull above.

The two-layered optical recording medium shown in FIG. 1 is possible to be prepared with the structure where an intermediate layer, a second information layer, and a substrate are disposed on the first information layer in this sequence, but generally, only just disposing a substrate on an inorganic layer (namely a second reflective layer) does not make the layers laminated. Then, there is a method for bonding a substrate on an inorganic layer using a resin or the like, however, because of unevenness of the thickness of an intermediate layer in addition to unevenness of the thickness of an adhesive layer made from a resin or the like, evenness of the overall layer thickness cannot be ensured, and recording and reproducing properties (jitter or the like) becomes worsen.

Hence, the two-layered optical recording medium of the present invention is prepared as follows. First, a second information layer is formed on a substrate, and a first information layer is separately formed on a cover substrate, and the substrate and the cover substrate are bonded through an intermediate layer so that the first and the second information layers are disposed inside of these substrates. According to the method, evenness of the overall layers becomes favorable, because it is affected by just only unevenness of thickness of the intermediate layer.

Examples of the substrate 1 include a polycarbonate resin, an acrylic resin, an epoxy resin, a polystyrene resin, an acrylonitrile-styrene copolymer, a polyethylene resin, a polypropylene resin, a silicone resin, a fluorocarbon resin, an ABS resin, and a urethane resin. A polycarbonate resin and an acrylic resin are particularly preferable, because both resins respectively excel in optical properties and cost.

Grooves with a pitch of 0.8 μm or less are generally provided on the substrate 1, but the grooves are not necessarily rectangular or trapezoidal geometrically. For instance, optical grooves with the waveguide having different refractive indexes or the like, formed thereon may be formed on the substrate 1 by means of, for example, ion implantation.

The thickness of the substrate 1 can be changed to take away chromatic aberration attributable to an evaluation pickup lens numerical aperture (NA). The substrate is preferably sheet-like in shape, because the substrate is generally required to have a thickness of 0.6 mm when the numerical aperture (NA) being about 0.6 to about 0.65 and is required to have a thickness of about 0.1 mm when the NA being about 0.85.

As a method for forming a thin layer substrate using a transparent sheet, there is the one that a transparent sheet is laminated through an ultraviolet curable resin or a transparent pressure sensitive adhesive double coated sheet. Besides, a thin layer substrate may be formed by coating an ultraviolet-ray (UV) curable resin on a protective layer by curing the coated surface.

Resins are utilized for an intermediate layer and an adhesive layers, but an UV curable resin excels in terms of cost.

As the above-noted dye materials, materials containing, for example, a cyanine dye, a phthalocyanine dye, a squarylium dye, and an azo metal chelate dye are preferable. By using these dyes, a small mark is easily formed, and it is possible to respond to high-density recording. These dye layers are usually formed by spin-coating.

The thickness of the first and the second dye layers is preferably 30 nm to 150 nm. If the thickness is thinner than 30 nm, it becomes harder to obtain a satisfactory contrast and the modulation properties becomes smaller. On the other hand, if more than 150 nm, it becomes harder to write a small recording mark.

When performing high-density recording in which the shortest recording mark becomes 0.5 μm or less, the thickness of the dye layers is preferably 50 nm to 100 nm. If the thickness is thinner than 50 nm, it is not preferred because the reflectance becomes too low, and the thickness of the dye layers is liable to become uneven. On the other hand, if more than 100 nm, recording sensitivity gets worse due to an increased thermal capacity, and besides, an edge of recording mark tends to get disordered, and the jitter becomes higher due to unevenness of thermal conductivity.

After recording a mark, the mark is judged by observing deformation, and optical hole burning of dye layers caused by laser beam; and changes in reflectance caused by deformation of substrates. The difference in reflectance before and after recording is usually greater than 5%.

The second protective layer has a function for prevent reactions between the second dye layer and the intermediate layer to control the reflectance of the innermost layer far from laser beam irradiation side. This is also effective to prevent deformation of the intermediate layer surface caused raised temperature when recorded.

Materials of the second protective layer should be decided in consideration of the refractive index, thermal conductivity, chemical stability, mechanical strength, adhesiveness, and the like. A material having low thermal conductivity is desirable, and it is desired to be 1×10⁻³ pJ/(μm·N·nsec), as a rough guide for the thermal conductivity. It is noted that it is difficult to directly measure the thermal conductivity of a low thermal conductive material in a thin-layered condition, and as an alternative method, a rough guide of thermal conductivity can be obtained based on thermal simulation results and actual measurement results of recording sensitivity.

Examples of the low thermal conductive material include a compound dielectric material comprising at least one element selected from ZnS, ZnO, SiC, TaS₂, and a rare-earth sulfide for 50 mole percent to 90 mole percent, having high transparency, and further comprising a heat-resistant compound with the melting point or the decomposition point being 1000° C. or more. More specifically, examples of the low thermal conductive material include a compound dielectric material comprising 70 mole percent to 90 mole percent of ZnS or ZnO, and a compound dielectric material comprising 60 mole percent to 90 mole percent of a rare-earth sulfide, such as La, Ce, Nd, and Y.

Examples of the heat-resisting compound material with the melting point or the decomposition point being 1000° C. or more include an oxide, a nitride, and a carbide, such as Mg, Ca, Sr, Y, La, Ce, Ho, Er, Yb, Ti, Zr, Hf, V, Nb, Ta, Zn, Al, Si, Ge, and Pb; a fluoride, such as Ca, Mg, and Li.

The above noted oxides, sulfides, nitrides, carbides, and fluorides do not necessarily take a stoichiometric composition, and the composition may be controlled or mixed for controlling refractive index, and the like.

As a material for the second protective layer, a composition mixed with ZnS and any one of SiO₂ or SiC is the most preferable material if taking into account of the above-mentioned key points to consider and compatibility with materials constituting the second dye layer.

From the perspective of recording sensitivity, a structure in which a layer having a high transmittance and a high thermal-conductivity is disposed as a protective layer on the intermediate layer side is also advantageous.

The thickness of the second protective layer is preferably 40 nm to 120 nm when the laser beam wavelength at the time of recording ranging from 600 nm to 700 nm, and when the laser beam wavelength is 350 nm to 600 nm, the thickness of the second protective layer is preferably 30 nm to 100 nm, and more preferably 40 nm to 80 nm.

As a material for the first protective layer, for example, a material having a high transmittance and a high thermal conductivity which comprises at least one element selected from In₂O₃, ZnO, ZrO, Ti₂O₃, SnO, Al₂O₃, and SiO₂, is used, and thereby thermal deformation of the second reflective layer can be reduced. Examples of a preferable material for the first protective layer include ITO (In₂O₃+SnO), and IZO (In₂O₃+ZnO).

The thickness of the first protective layer is preferably 40 nm to 120 nm when the laser beam wavelength at the time of recording ranging from 600 nm to 700 nm, and when the laser beam wavelength is 350 nm to 600 nm, the thickness of the first protective layer is preferably 30 nm to 100 nm, and more preferably 40 nm to 80 nm.

To make it possible to make a reflectance of the first protective layer equivalent to that of the second protective layer and to obtain favorable jitter results, it is required to define the total thickness of the first and the second protective layers to be 120 nm or more (refractive index*total thickness≧260 nm), while setting the laser beam wavelength in recording at 660 nm, and the refractive index at 2.2. The reason comes from the fact that a dye induces optical changes (changes in refractive index and specific consumption) besides deformation when recorded.

When forming the first and second protective layers with a thickness of 120 nm or more using one chamber of a sputtering apparatus at a time, the thickness is liable to become uneven, and when increasing the refractive index and making the thickness thinner, the refractive index and layer producing rate are liable to change. Then, to keep evenness of the thickness of the first and second protective layers, it is preferred to prepare the layers in two or more batches using two or more chambers. That is, when forming the first protective layer and/or the second protective layer so as to become thick, it is preferred that a protective layer is configured to have two or more layers made from same materials. It is desired to use a DC sputtering, because a RF sputtering induces substantial changes in deformation and optical properties.

In the case of a layer-structure shown in FIG. 1, light absorption occurs in the second dye layer when recorded, and the second layer generates heat in accordance with the light absorption, but the heat has a thermal conductivity higher than that of the first protective layer and dissipated mainly from the second reflective layer which is adjacent to the second dye layer and at the same time, also dissipated through the second protective layer from the first protective layer which has a thermal conductivity higher than that of the second protective layer. As a result, a small recording mark can be formed, and high-density recording becomes possible. Further, in the case of a layer-structure where there is no first protective layer provided, as in conventional layer-structures, thermal deformation occurs in the second reflective layer, which is disposed at the innermost side of the information layer far from laser beam irradiation side, where heat is liable to accumulate, but the layer-structure of the present invention enables preventing deformation of the second reflective layer. However, the thickness of the second reflective layer is preferably 130 nm or more. If the thickness of the second reflective layer is less than 130 nm, the deformation of the second reflective layer may become remarkable, even if a first protective layer is provided.

With respect to the optical recording medium of Example 1, hereafter will be described; FIG. 2 shows the push-pull of the second information layer in the case where the second reflective layer's thickness is changed. FIG. 2 shows that the thickness of the second reflective layer is preferably 130 nm or more, because when the thickness is less than 130 nm, a groove signal drastically becomes deteriorated.

As stated above, it is preferred that the first protective layer is formed and then the thickness of the second reflective layer is preferably 130 nm or more, and more preferably 150 nm or more. By setting the thickness of the second reflective layer 130 nm or more, deformation of the second reflective layer becomes lessen, there is no deterioration of groove signal properties, tracking and addresses can be read with accuracy, and recording and reproducing properties become preferable.

As a material of the first reflective layer (semi-translucent layer) and the second reflective layer, there are Ag or an Ag alloy, Au, Al alloy, and the like, which are suitable for quenching and materials with high thermal conductivity.

Examples of the Ag alloy include the one that comprises 0.2 atomic percent to 5 atomic percent of one element selected from Cu, Ti, V, Ta, Nb, W, Co, Cr, Si, Ge, Sn, Sc, Hf, Pd, Rh, Au, Pt, Mg, Zr, Mo, or Mn. When greater importance is placed on temporal stability of the first and the second reflective layers, Ti or Mg is preferable as the component to be added to Ag.

It is verified for the Ag alloys that the volume resistivity of the Ag alloys increases in proportion to concentration of the added element. However, it is believed that the addition of impurities generally makes a crystalline particle diameter smaller and makes grain boundary scattering increased to lower thermal conductivity. Thus, it is required to control the amount of impurities to be added to Ag in order for obtaining the material's intrinsic high thermal conductivity by increasing the crystalline particle diameter.

Examples of the Al alloy include the one that comprises 0.2 atomic percent to 2 atomic percent of one element selected from Ta, Ti, Co, Cr, Si, Sc, Hf, Pd, Pt, Mg, Zr, Mo, or Mn. The volume resistivity of the Al alloy increase in proportion to concentration of the added element and hillock resistivity is also improved, therefore, these elements can be used in consideration of durability, volume resistivity, film-forming rate, and the like. When the added amount of impurities is less than 0.2 atomic percent, it is often the case that the hillock resistivity is insufficient, depending on the film-forming conditions though. When the added amount of impurities is more than 2 atomic percent, it becomes harder to obtain low resistivity. When greater importance is placed on temporal stability of the first and second reflective layers, Ta is preferable as the component to be added to Al.

It is preferred to make the thickness of the first reflective layer (semi-translucent layer) thin to make laser beam transmitted. For this reason, it is necessary to remove unevenness of the thickness by delaying the deposition rate in film-forming. The thickness of the first reflective layer is preferably 5 nm to 20 nm. If the thickness is less than 5 nm, the thickness may become uneven, even if the deposition rate is delayed.

As for a preparing method of the first and the second reflective layers, a sputtering method and a vacuum evaporation method are usually used, and it is preferable that the total amount of impurities including not only for the target and evaporation materials but also moisture and the amount of oxygen mixed in film-forming is 2 atomic percent or less. Thus, the base vacuum process chamber pressure is preferably 1×10⁻³ Pa or less. When film-forming is performed with an ultimate vacuum lower than 1×10⁻⁴ Pa, it is preferred to prevent impurities being introduced by setting a film-forming rate at 1 nm/sec. or more, and more preferably 10 nm/sec. or more. When more than one atomic percent of an intended additional element is included, it is preferred to set the film-forming rate at 10 nm/sec. or more to prevent additional impurities from being mixed as much as possible.

In the present invention, in order to define high thermal conductivity of the first and the second reflective layers showing good properties, whether the thermal conductivity is good or bad can be estimated using electric resistivity, although it is also possible to directly measure the respective thermal conductivities for the first reflective layer and the second reflective layer. It is because, in materials that electron controls thermal conductivity or electric conductivity, there is a proportionality relation between thermal conductivity and specific electric conductivity.

Here, the electric resistivity of a thin layer is expressed by the electric resistivity value standardized based on the thickness and the dimension of measured area. Volume resistivity and dimension resistivity can be measured by a four-probe technique usually used and are standardized by JIS N7194. The method enables obtaining data with good reproductivity in a much easier way than directly measuring thermal conductivity of a thin layer itself.

With respect to volume resistivity of the first reflective layer and the second reflective layer, a material having a volume resistivity of 20 nΩ·m to 150 nΩ·m, particularly 20 nΩ·m to 100 nΩ·m, is used. If the volume resistivity is less than 20 nΩ·m, it is practically difficult to obtain a layer in a thin-film condition. Examinations by the inventors of the present invention show that even when the volume resistivity is more than 150 nΩ·m, for example, in the case of a layer having a thickness more than 300 nm, it makes possible to decrease the dimension resistivity, but a sufficient heat dissipation effect cannot be obtained with such a high volume resistivity material with such a high volume resistive material, even with just only decreasing dimension resistivity. It is considered that this is because in the case of a thick film layer, the thermal capacity of per unit area becomes increased. Since it takes long hours to prepare such a thick film layer and costs much in materials, it is not preferable in terms of manufacturing cost as well as the microscopic evenness of the layer surface gets worse. Thus, it is preferable to use a material having a thickness of 300 nm or less and low volume resistivity enough to obtain a dimension resistivity of 0.2 Ω/square to 0.9 Ω/square, and a material with a dimension resistivity of 0.5 Ω/square is most preferable.

When the first information layer and the second information layer respectively have a reflectance ranging from 15% to 30%, information can be reproduced with a DVD player. Usually, DVD- ROM standard defines its reflectance as 18% to 30%, but if a reflectance of 15% is ensured, it actually becomes possible to reproduce information with a DVD player. However, when the reflectance is 12% or more to less than 15%, there may be either case where information can be reproduced or cannot be reproduced, and when the reflectance is less than 12%, information cannot be reproduced. In other words, if the reflectance is 15% or more, the recording medium has DVD reproductive compatibility. As to the upper limit of the reflectance, it may be same as that of DVD standard, as 30%, because if setting two dye layers (a medium having one recording layer has a reflectance of approx. 50%), the reflectance of respective layers does not reach 30%. That is to say, as a two-layered optical recording medium using dye layers, if a reflectance of 15% or more is cleared, the optical recording medium has DVD reproductive compatibility.

(Method for Manufacturing a Two Layered Optical Recording Medium)

The method for manufacturing a two layered optical recording medium of the present invention is intended for manufacturing the two layered optical recording medium in accordance with the present invention and comprises a step for forming and disposing a plurality of layers using same materials to form at least any one of a first protective layer and a second protective layer and further comprises other steps as required.

In the process for forming a protective layer, to keep evenness of the thickness of the first and second protective layers, it is preferred to prepare the layers in two or more batches using two or more chambers. That is, when forming the first protective layer and/or the second protective layer so as to become thick, it is preferred that a protective layer is configured to have two or more layers made from same materials. It is desired to use a DC sputtering, because a RF sputtering induces substantial changes in deformation and optical properties.

(Method for Optical Recording and Reproducing)

In the method for optical recording and reproducing according to the present invention using the optical recording medium of the present invention, at least any one of recording and reproducing of signal information on a first dye layer and a second dye layer by irradiating laser beam to the two-layered optical recording medium of the present invention from a first information layer side.

Specifically, laser beam for recording, such as a laser diode (for instance, laser emission wavelength of 650 nm) is irradiated to the optical recording medium from the first information layer side through an object lens while rotating the recording medium at a given linear velocity or a given constant angular velocity. By the irradiation of laser beam, the first dye layer and the second dye layer absorb the laser beam and increase the temperature locally, for instance, to generate a pit, and by changing the optical properties of the pit, signal information is recorded. Reproduction of the recording information as described above can be performed by irradiating laser beam to an optical recording medium from the substrate side while rotating the optical recording medium at a given linear velocity and then by detecting the reflected rays.

(Apparatus for Optical Recording and Reproducing)

The apparatus for recoridng and reproducing according to the present invention is an apparatus in which recording and reproducing of information are performed in an optical recording medium by irradiating laser beam to the optical recording medium from light source, and the two-layered optical recording medium of the presen invention is used.

The apparatus for recording and reproducing is not particularly limited and may be selected in accordance with the intended use. Examples of the apparatus include the one that comprises a laser beam source which is a light source for outputing laser beam such as a laser diode; a condenser lens for condensing laser beam output from the leaser beam source on an optical recording medium equipped on a spindle; a laser beam detector for detecting a part of laser beam output from the laser beam source; an optical element for guiding laser beam output from the laser beam source to the condenser lens and the laser beam detector , and fuother comprises other units as required.

In the apparatus for optical recording and reproducing, leaser beam output from the laser beam source is guided to the condenser lens through the optical element, and the laser beam is focused on and irradiated to the recording medium by the condensor lens to perform recording and reproducing in the optical recording medium. At that time, the optical recording and reproducing appratus guides a part of laser beam output from the laser beam source to the laser beam detector and control laser intensity based on the detected amount of the laser beam detected by the laser beam detector.

The laser beam detector converts the detected amount of laser beam into power voltage or power current to output it as a detected amount signal.

As an example of other units mentioned above, there are controlling unit, or the like. The controlling unit is not particularly limited provided that the movements of each of these units stated above can be controlled and may be selected in accordance with the intended use. Examples of the controlling unit include an instrument such as a sequencer, and computer.

The appratus of recoridng and reproducing according to the present invention has high reflectance and high degree of modulation and enables recording in a stable manner, because the apparatus carries the two-layered optical recording medium of the present invention which makes it possible to obtain good recording signal properties and to suppress the amout of crosstalk of a recording mark.

According to the present invention, it is enabled to provide a two-layered optical recording medium using dye layers for a recording layer which triggers no jitter noise and the like against not only a red laser beam but also against low-power output laser beam such as a blue laser beam, has high archival properties, and is capable of high-density recording, and a method and an apparatus for the optical recording and reproducing.

Hereafter, the present invention will be described referring to specific examples; however, the present invention is not limited to the disclosed examples. On the contrary, the present invention is intended to cover various modifications and equivalent arrangements included within the spirit and scope of the appended claims.

### EXAMPLE 1

-Preparation of Two-Layered Optical Recording Medium-

A first dye layer (a squarylium dye) and a first reflective layer (semi-translucent layer) (Ag₉₇/Pd₁/Cu₁/In₁) were disposed on a cover substrate made from a polycarbonate resin. On the other hand, a second reflective layer (Ag₉₇/Pd₁/Cu₁/In₁), a second dye layer (a squarylium dye), a second protective layer [ZnS:SiC (mole ratio: 80:20)] and a first protective layer (ITO: In₂O₃+SnO) were disposed on a substrate. Inorganic layers were formed by sputtering, and dye layers were formed by spin-coating.

Next, the cover substrate with the first dye layer or the like formed thereon and the substrate with the second dye layer or the like formed thereon were laminated each other through an intermediate layer (DVD576, manufactured by Nippon Kayaku Co., Ltd.) such that these dye layers were disposed inside of the cover substrate and the substrate to prepare a two-layered optical recording medium having the layer structure shown in FIG. 1.

These layers were prepared by controlling the thickness of each of these layers to be a thickness as follows:

A cover substrate: 0.57 mm, a substrate: 0.57 mm, a first dye layer: 50 nm, a first reflective layer: 10 nm, an intermediate layer: 50 μm, a first protective layer: 50 nm, a second protective layer: 70 nm, a second dye layer: 60 nm, and a second reflective layer: 170 nm.

### EXAMPLE 2

-Preparation of Two-Layered Optical Recording Medium-

A two-layered optical recording medium for Example 2 was prepared in the same manner as Example 1 except that the thickness of the second reflective layer was changed to 150 nm and the constitutional material was changed to Au.

### EXAMPLE 3

-Preparation of Two-Layered Optical Recording Medium-

A two-layered optical recording medium for Example 3 was prepared in the same manner as Example 1 except that the thickness of the first reflective layer (semi-translucent layer) was changed to 20 nm and the constitutional material was changed to Al₉₉/Ti₁.

### EXAMPLE 4

-Preparation of Two-Layered Optical Recording Medium-

A two-layered optical recording medium for Example 4 was prepared in the same manner as Example 1 except that the thickness of the first protective layer was changed to 50 nm and the constitutional material was changed to IZO (In₂O₃+ZnO).

### EXAMPLE 5

-Preparation of Two-Layered Optical Recording Medium-

A two-layered optical recording medium for Example 5 was prepared in the same manner as Example 1 except that the thickness of the first protective layer was changed to 50 nm and the constitutional material was change to a mixture of ZrO and Ti₂O₃ (mole ratio: 70:30).

### EXAMPLE 6

-Preparation of Two-Layered Optical Recording Medium-

A two-layered optical recording medium for Example 6 was prepared in the same manner as Example 1 except that the thickness of the first protective layer was changed to 50 nm and the constitutional material was changed to a mixture of Al₂O₃ and SiO₂ (mole ratio: 50:50).

### COMPARATIVE EXAMPLE 1

-Preparation of Two-Layered Optical Recording Medium-

A two-layered optical recording medium for Comparative Example 1 was prepared in the same manner as Example 1 except that the first protective layer was eliminated and the thickness of the second protective layer was changed to 120 nm.

### COMPARATIVE EXAMPLE 2

-Preparation of Two-Layered Optical Recording Medium-

A two-layered optical recording medium for Comparative Example 2 was prepared in the same manner as Example 1 except that the first protective layer was eliminated, the thickness of the second protective layer was changed to 120 nm, and the thickness of the second reflective layer was changed to 80 nm.

With respect to each of these two-layered optical recording media obtained in Examples 1 through 6 and Comparative Examples 1 and 2, a focusing laser beam was irradiated to each of these two-layered optical recording media using an optical apparatus having a wavelength of 660 nm, a lens numerical aperture (NA) of 0.65, and then push-pull signals, which are an initial jitter, a recording power (power showing the minimal jitter), and groove signal properties, were evaluated under conditions of linear velocity: 3.5 m/s and 0.267 μm/bit. The reflectance of each individual two-layered optical recording media were also evaluated. Table 1 and Table 2 respectively show the results.

TABLE 1

| | Initial Jitter | Initial Jitter | Push-pull | |
|---|---|---|---|---|
| | (%) of 1^{st} | (%) of 2^{nd} | signal of 1^{st} | Push-pull |
| | Information | Information | Information | signal of 2^{nd} |
| Example | layer | layer | layer | Information layer |
| Ex. 1 | 6.3 | 6.2 | 0.40 | 0.45 |
| Ex. 2 | 6.5 | 6.7 | 0.39 | 0.46 |
| Ex. 3 | 6.4 | 7.3 | 0.40 | 0.49 |
| Ex. 4 | 7.0 | 6.5 | 0.39 | 0.47 |
| Ex. 5 | 7.2 | 6.9 | 0.38 | 0.48 |
| Ex. 6 | 7.1 | 7.2 | 0.42 | 0.46 |
| Compara. | 7.3 | 13.4 | 0.40 | 0.30 |
| Ex. 1 | | | | |
| Compara. | 7.3 | 7.9 | 0.40 | 0.22 |
| Ex. 2 | | | | |

TABLE 2

| | Reflectance (%) of | Reflectance (%) of 2^{nd} |
|---|---|---|
| Example | 1^{st} Information layer | Information layer |
| Ex. 1 | 18.0 | 17.3 |
| Ex. 2 | 18.1 | 17.2 |
| Ex. 3 | 18.2 | 17.1 |
| Ex. 4 | 18.2 | 17.5 |
| Ex. 5 | 18.6 | 17.2 |
| Ex. 6 | 18.1 | 17.5 |
| Compara. | 18.3 | 16.1 |
| Ex. 1 | | |
| Compara. | 18.2 | 14.2 |
| Ex. 2 | | |

### EXAMPLE 7

-Preparation of Two-Layered Optical Recording Medium-

A two-layered optical recording medium for Example 7 was prepared in the same manner as Example 1 except that the thickness of the first protective layer was changed to 120 nm, and the thickness of the second protective layer was changed to 10 nm.

In the course of the preparation, just first protective layers were prepared and compared with other first protective layers under the following different conditions.

When forming a first protective layer having a thickness of 120 nm, the one formed to have individual two layers respectively having a thickness of 60 nm using two chambers (two layers); the one formed to have individual three layers respectively having a thickness of 40 nm using three chambers (three layers); and the one formed using one chamber (one layer) were compared. Individual layer producing rates were measured in the first stage to utilize the rates and then control individual sputtering hours so as to obtain individual layers of the first protective layers respectively having a thickness of 60 nm (two chambers: total thickness of two layers is 120 nm), 40 nm (three chambers: total thickness of three layers is 120 nm), and 120 nm (one chamber: one layer).

The obtained each thickness of layers was measured by using ETA-RT (manufactured by Steag ETA-Optics GmbH). The measurement was performed by forming just a first protective layer on a substrate made from a glass set on a blue tempered glass (thickness: 0.6 mm).

The results are as shown below. When a thickness of a layer was controlled with one chamber, it became approx. 10 nm thicker than that of the preset and controlled value. It is noted that an intermediate circumference resides at a radius of 40 mm, an inner circumference resides at a radius of 24 mm, and an outer circumference resides at 58 mm.

| | Intermediate | Inner | Outer |
|---|---|---|---|
| | circumference | circumference | circumference |
| 2 chamber | 119 nm | 118.5 nm | 117 nm |
| 3 chamber | 121 nm | 120 nm | 119 nm |
| 1 chamber | 130 nm | 128 nm | 126 nm |

Next, the results of measurement of each of these entire protective layers (a first protective layer+a second protective layer) are as follows:

| | Intermediate | Inner | Outer |
|---|---|---|---|
| | circumference | circumference | circumference |
| 2 chamber | 129 nm | 128.5 nm | 127 nm |
| 3 chamber | 131 nm | 130 nm | 129 nm |
| 1 chamber | 140 nm | 138 nm | 136 nm |

With respect to the thicknesses of the second protective layers, they were formed nearly as preset and controlled, since the second protective layer was intended to have a thin layer of 10 nm.

Reflectance and jitter results of the second information layer viewed from the direction of laser beam irradiation are as follows:

| | | Jitter value |
|---|---|---|
| | | (Intermediate |
| | Reflectance | circumference) |
| 2 chamber | 16.9% | 7.1% |
| 3 chamber | 17.2% | 6.9% |
| 1 chamber | 15.1% | 11.4% |

When a second protective layer was formed with one chamber, the reflectance showed a large gap and resulted in approx. 2% lower than the preset value of 17% and the jitter showed an unfavorable result of 11.4%.

### EXAMPLE 8

-Preparation of Two-Layered Optical Recording Medium-

A two-layered optical recording medium for Example 8 was prepared in the same manner as Example 1 except that the thickness of the first protective layer was changed to 120 nm, and the second protective layer was eliminated. Results much the same as the first protective layer of Example 7 were obtained.

When forming a first protective layer having a thickness of 130 nm, the one formed to have individual two layers respectively having a thickness of 65 nm using two chambers (two layers); the one formed to have individual three layers respectively having a thickness of 43.3 nm using three chambers (three layers); and the one formed using one chamber (one layer) were compared. Individual layer producing rates were measured in the first stage to utilize the rates and then control individual sputtering hours so as to obtain individual layers of the first protective layers respectively having a thickness of 65 nm (two chambers: total thickness of two layers is 130 nm), 43.3 nm (three chambers: total thickness of three layers is 130 nm), and 130 nm (one chamber: one layer).

The obtained each thickness of layers was measured by using ETA-RT (manufactured by Steag ETA-Optics GmbH). The measurement was performed by forming just a first protective layer on a substrate made from a glass set on a blue tempered glass (thickness: 0.6 mm).

The results are as shown below. When a thickness of a layer was controlled with one chamber, it became approx. 10 nm thicker than that of the preset and controlled value. It is noted that an intermediate circumference resides at a radius of 40 mm, an inner circumference resides at a radius of 24 mm, and an outer circumference resides at 58 mm.

| | Intermediate | Inner | Outer |
|---|---|---|---|
| | circumference | circumference | circumference |
| 2 chamber | 129 nm | 128.5 nm | 127 nm |
| 3 chamber | 131 nm | 130 nm | 129 nm |
| 1 chamber | 141 nm | 138 nm | 135 nm |

Reflectance and jitter results of the second information layer viewed from the direction of laser beam irradiation are as follows:

| | | Jitter value |
|---|---|---|
| | | (Intermediate |
| | Reflectance | circumference) |
| 2 chamber | 17.0% | 7.0% |
| 3 chamber | 17.5% | 6.6% |
| 1 chamber | 15.0% | 12.3% |

When a first protective layer was formed with one chamber, the reflectance showed a large gap and resulted in approx. 2% lower than the preset value of 17% and the jitter showed an unfavorable result of 12.3%.

Table 1 and Table 2 show that Examples 1 through 6 had preferable results as to both the initial jitter and the push-pull signal of the second information layer, but in the case the first protective layer being eliminated or in the case where the first protective layer is eliminated and the thickness of the second reflective layer is thinner, as in Comparative Examples 1 and 2, both the initial jitter and the push-pull signal marked poor results, groove signal properties were low, and tracking properties were also poor, and therefore, the recording and reproducing properties were also poor.

The two-layered optical recording media of Examples 1 to 5 respectively had a reflectance of 15% or more and enabled reproducing with a DVD reproductive player, but in Comparative Example 2, the reflectance was 14.2%, and it was impossible to perform reproducing using a DVD reproductive player.

1. A two-layered optical recording medium comprising:
a substrate,
a second information layer, an intermediate layer, and the first
information layer disposed on the substrate in this sequence,
wherein recording and reproducing are performed on the first information layer and the second information layer respectively by irradiating laser beam from the first information layer side,
wherein the first information layer comprises at least
a first dye layer which comprises an organic dye, and
a first reflective layer disposed on the first dye layer,
wherein the second information layer comprises at least
a second dye layer which comprises an organic dye, and
a second reflective layer disposed on the second dye layer,
wherein the first reflective layer is semi-translucent, and
wherein the two-layered optical recording medium comprises a first protective layer and a second protective layer disposed between the second dye layer and the intermediate layer.

2. The two-layered optical recording medium according to claim 1, wherein the first reflective layer respectively comprise one element selected from Ag, an Ag alloy, Au, and an Al alloy.

3. The two-layered optical recording medium according to claim 1, wherein the first protective layer comprises at least one element selected from In₂O₃, ZnO, ZrO, Ti₂O₃, SnO, Al₂O₃, and SiO₂.

4. The two-layered optical recording medium according to claim 1, wherein the first information layer and the second information layer respectively have a reflectance of 15% to 30%.

5. The two-layered optical recording medium according to claim 1, wherein the first reflective layer and the second reflective layer comprise at least one element selected from Ag, an Ag alloy, Au, and an Al alloy.

6. The two-layered optical recording medium according to claim 1, wherein the first reflective layer has a thickness of 5 nm to 20 nm.

7. The two-layered optical recording medium according to claim 1, wherein the second reflective layer has a thickness of 130 nm or more.

8. The two-layered optical recording medium according to claim 1, wherein the first dye layer and the second dye layer comprise at least one element selected from a cyanine dye, a phthalocyanine dye, a squarylium dye, and an azo metal chelate dye.

9. The two-layered optical recording medium according to claim 1, wherein the first dye layer and the second dye layer respectively have a thickness of 30 nm to 150 nm.

10. The two-layered optical recording medium according to claim 1, wherein the optical recording medium comprises a cover substrate, the first dye layer, the first reflective layer, the intermediate layer, the first protective layer, the second protective layer, the second dye layer, the second reflective layer and the substrate in this sequence from laser beam irradiation side.

11. A two-layered optical recording medium comprising:
a substrate,
a second information layer, an intermediate layer, and the first
information layer disposed on the substrate in this sequence,
wherein recording and reproducing are performed on the first information layer and the second information layer respectively by irradiating laser beam from the first information layer side,
wherein the first information layer comprises at least
a first dye layer which comprises an organic dye, and
a first reflective layer disposed on the first dye layer,
wherein the second information layer comprises at least
a second dye layer which comprises an organic dye, and
a second reflective layer disposed on the second dye layer,
wherein the first reflective layer is semi-translucent,
wherein the two-layered optical recording medium comprises a protective layer disposed between the second dye layer and the intermediate layer,
wherein the protective layer comprises a plurality of layers made from same materials.

12. The two-layered optical recording medium according to claim 11,
wherein the first reflective layer respectively comprise one element selected from Ag, an Ag alloy, Au, and an Al alloy.

13. The two-layered optical recording medium according to claim 11, wherein the first protective layer comprises at least one element selected from In₂O₃, ZnO, ZrO, Ti₂O₃, SnO, Al₂O₃, and SiO₂.

14. The two-layered optical recording medium according to claim 11, wherein the first information layer and the second information layer respectively have a reflectance of 15% to 30%.

15. The two-layered optical recording medium according to claim 11, wherein the first reflective layer and the second reflective layer comprise at least one element selected from Ag, an Ag alloy, Au, and an Al alloy.

16. The two-layered optical recording medium according to claim 11, wherein the first reflective layer has a thickness of 5 nm to 20 nm.

17. The two-layered optical recording medium according to claim 11, wherein the second reflective layer has a thickness of 130 nm or more.

18. The two-layered optical recording medium according to claim 11, wherein the first dye layer and the second dye layer comprise at least one element selected from a cyanine dye, a phthalocyanine dye, a squarylium dye, and an azo metal chelate dye.

19. The two-layered optical recording medium according to claim 11, wherein the first dye layer and the second dye layer respectively have a thickness of 30 nm to 150 nm.

20. The two-layered optical recording medium according to claim 11, wherein the optical recording medium comprises a cover substrate, the first dye layer, the first reflective layer, the intermediate layer, the protective layer, the second dye layer, the second reflective layer and the substrate in this sequence from laser beam irradiation side.

21. A method for manufacturing a two-layered optical recording medium comprising:
disposing a plurality of layers by using same materials to form a protective layer,
wherein the two-layered optical recording medium comprises
a substrate,
a second information layer, an intermediate layer, and the first information layer disposed on the substrate in this sequence,
wherein recording and reproducing are performed on the first information layer and the second information layer respectively by irradiating laser beam from the first information layer side,
wherein the first information layer comprises at least
a first dye layer which comprises an organic dye, and
a first reflective layer disposed on the first dye layer,
wherein the second information layer comprises at least
a second dye layer which comprises an organic dye, and
a second reflective layer disposed on the second dye layer,
wherein the first reflective layer is semi-translucent, and
wherein the two-layered optical recording medium comprises the protective layer disposed between the second dye layer and the intermediate layer,

22. A method for optical recording and reproducing comprising:
irradiating laser beam to a two-layered optical recording medium from a first information layer side to perform at least any one of recording and reproducing of signal information on a first dye layer and a second dye layer,
wherein the two-layered optical recording medium comprises
a substrate,
a second information layer, an intermediate layer, and the first information layer disposed on the substrate in this sequence,
wherein recording and reproducing are performed on the first information layer and the second information layer respectively by irradiating laser beam from the first information layer side,
wherein the first information layer comprises at least
a first dye layer which comprises an organic dye, and
a first reflective layer disposed on the first dye layer,
wherein the second information layer comprises at least
a second dye layer which comprises an organic dye, and
a second reflective layer disposed on the second dye layer,
wherein the first reflective layer is semi-translucent, and
wherein the two-layered optical recording medium comprises a first protective layer and a second protective layer disposed between the second dye layer and the intermediate layer.

23. An apparatus for optical recording and reproducing comprising:
an optical recording medium in which at least any one of recording and reproducing are performed by irradiating laser beam to the optical recording medium; and
laser beam source from which laser beam is irradiated to the optical recording medium,
wherein the optical recording medium comprises
a substrate,
a second information layer, an intermediate layer, and the first
information layer disposed on the substrate in this sequence,
wherein recording and reproducing are performed on the first information layer and the second information layer respectively by irradiating laser beam from the first information layer side,
wherein the first information layer comprises at least
a first dye layer which comprises an organic dye, and
a first reflective layer disposed on the first dye layer,
wherein the second information layer comprises at least
a second dye layer which comprises an organic dye, and
a second reflective layer disposed on the second dye layer,
wherein the first reflective layer is semi-translucent, and
wherein the two-layered optical recording medium comprises a first protective layer and a second protective layer disposed between the second dye layer and the intermediate layer.
